(19) United States
(12) Patent Application Publication
(10) Pub. No.: US 2013/0294257 A1
(43) Pub. Date: Nov. 7, 2013

(54) Methods for Subscriber Tracing Based on Error History Information

(71) Applicants: Ester Gonzalez de Langarica, Stockholm (SE); Sarah Gannon, Stockholm (SE)

(72) Inventors: Ester Gonzalez de Langarica, Stockholm (SE); Sarah Gannon, Stockholm (SE)

(73) Assignee: TELEFONAKTIEBOLAGET L M ERICSSON (PUBL), Stockholm (SE)

(21) Appl. No.: 13/996,355

(22) PCT Filed: Dec. 28, 2010
(86) PCT No.: PCT/SE2010/051489

§ 371 Date: Jun. 20, 2013

(51) Int. Cl. H04L 12/26

(52) U.S. Cl. CPC H04L 43/10
USPC 370/242

(57) ABSTRACT

Methods and arrangements for subscriber tracing based on error history information, are disclosed. A method in a network node (104, 204,600) for providing trace records having error history information comprises receiving trace parameter configuration information (steps S-210, 302, from an Element Manager, EM, (202) activating a trace session, obtaining an error message (steps 304, 406), starting trace recording session (step S-216, 306, 412) if the obtained error message matches the trace parameter configuration information, and providing a trace record (steps S-222, 308, 418) to a trace collection entity (108, 208, 700), for troubleshooting of the network.

### TECHNICAL FIELD

This invention pertains in general to the field of subscriber tracing. More particularly the invention relates to methods for subscriber tracing based on error history information.

### BACKGROUND

Within the Third Generation Partnership Project (3GPP) tracing of subscriber and equipment is specified in the following specifications:
TS 32.421 V9.0.0, Subscriber and equipment trace: Trace concepts and requirements;
TS 32.422 V9.0.1, Subscriber and equipment trace: Trace control and configuration management; and
TS 32.423 V9.1.1, Subscriber and equipment trace: Trace data definition and management.

These specifications define the management of tracing and the reporting of the traces for different domains, including Internet Multimedia Subsystems (IMS).

Moreover, it is described how to trace active calls of a subscriber.

It has been noted that these Technical Specifications are incomplete, especially for IMS. For this reason, there is a need for further studies.

In order to meet this need Nettrace® has been introduced by the applicant for tracing of network signaling. Nettrace® is partially implemented in the Call Session Control Function (CSCF) node for the SIP signaling.

Nettrace® is one of the initiatives to reduce Total Cost of Ownership (TCO) for operators by providing network level troubleshooting based on subscriber.

Products meeting the requirements of TCO must have a tracing functionality that is capable of tracing: product variables, software module interaction and program execution in real time without negatively impacting the network traffic.

NetTrace® will be implemented to provide signaling tracing as defined by 3GPP. It shall also be possible to correlate signaling traces from individual nodes to create a single system trace where applicable.

According to a TCO requirement each node shall create trace profiles that can be enabled or disabled to allow tracing at an internal functional level once it is perceived that there is a problem in the functional area.

The purpose of performing tracing of signaling, i.e. signaling tracing is troubleshooting. The operator may want to trace the activity of the user, that is, the signaling traversing different IMS nodes to locate where in the network a problem is located. Once the “erroneous” node has been located, the troubleshooting can continue for this specific node by applying an internal or more detailed tracing.

Typically, the operator wants to trace the entire “call”, in contrast to a single Session Initiation Protocol (SIP) session, or leg. Thus, the operator wants to trace the end to end SIP+Diameter signaling, for example Registration, A->B calls, Supplementary services, and so on.

In order to trace the “call”, the Operation Support System (OSS) will create a Trace Session in all the Network Elements for that specific user. The Trace Session comprises a list of parameters, of which the main parameters are the identifier of the Trace Session Reference (TSR) and the triggering start and stop criteria, which defines when to start and stop tracing, respectively.

When the criteria are matched, each NE will generate an XML file according to the 3GPP defined scheme, comprising the message being signaled.

Ideally, when a user calls and has a complaint, the operator should be able to correct the user's problem without causing any inconveniences for the user.

Sometimes the operator needs to utilize the subscriber tracing system to see the signaling path and detect potential error codes and in this way, locate where the fault is.

Such a solution suffers from the problem of that subscriber tracing is not activated by default for all users. Therefore, the operator may have to ask the end user to perform the same actions again, in order to reproduce the user's problem.

For example, if user A fails to call user B, the operator will ask user A to try to call user B again. Before A calls B a second time, the operator activates subscriber tracing. With subscriber tracing switched on, error codes can be searched and the location of the error sought.

There is hence, there is a need for methods for tracing that does not suffer from the mentioned drawbacks.

### SUMMARY

The present invention seeks to mitigate, alleviate or eliminate one or more of the above-identified deficiencies in the prior art and disadvantages singly or in any combination and solves at least the above mentioned problem by providing a method and an arrangement according to the appended patent claims.

The general solution is to base subscriber tracing on error history information. According to one aspect of the present invention, a method in a network node for providing trace records having error history information, is disclosed. The method comprises receiving trace parameter configuration information from an Element Manager, EM, activating a trace session, and obtaining an error message. If the obtained error message matches the trace parameter configuration information, a trace recording session is started. A trace record is provided to a trace collection entity for troubleshooting of the network.

The step of obtaining an error message in the method may comprise detecting an error message within the network node.

The step of obtaining an error message in the method may comprise receiving an error message from another network node.

The method may further comprise comparing the obtained error messages and the trace parameter configuration information.

The method may further comprise awaiting obtaining another error message, in absence of a match between the obtained error message and the trace parameter configuration information.

The method may further comprise detecting an event triggering stopping of the trace recording session.

According to a second aspect of the present invention, a method in a network node for processing of trace records with error history information, related to a number of users, from network nodes for network troubleshooting, is disclosed. The method comprises receiving at least one trace record that has error history information from at least a first network node, and correlating said trace records with one another. The correlated trace records are filtered based on user identities.

The method in a network node for processing of trace records with error history information, may further comprise receiving a trace recording session reference for each trace record, and wherein correlating said trace records is based on one or more received trace recording session references.

According to a third aspect of the present invention, a network node for providing trace records having error history information, is disclosed. The network node comprises a transceiving unit that is configured to receive trace parameter configuration information, and to obtain an error message.

The network node also comprises a control unit operatively connected to the receiving unit, and configured to start trace recording session if the obtained error message matches the trace parameter configuration information. In addition, a transceiving unit is configured to provide a trace record to a trace collection entity, for troubleshooting of the network.

According to a fourth aspect of the present invention, a network node for processing of trace records with error history information, related to a number of users, from network nodes for network troubleshooting, is disclosed. This network node comprises a receiving unit that is configured to receive trace records which have error history information from at least a first network node. The network node for processing of trace records with error history information also comprises a control unit that is operatively connected to the receiving unit, and configured to correlate trace records which have error history information from at least a first network node. Moreover, said control unit is also configured to filter the correlated trace records based on user identities.

Embodiments of the present invention come with the following advantages: Traces containing the error will be available before the user calls with his complaint, since tracing based on errors can be activated in beforehand. This allows the operator to react better and faster when the user calls or even before the user calls, performing some preventive actions.

### BRIEF DESCRIPTION OF DRAWINGS

These and other aspects, features and advantages of which the invention is capable of will be apparent and elucidated from the following description of embodiments of the present invention, reference being made to the accompanying drawings, in which

FIG. 1 presents a tracing enabled communication network related to the present invention;

FIG. 2 illustrates a signal flow diagram related to embodiments of the present invention;

FIGS. 3, 4 and 5 each presents a flowchart of method steps related to embodiments of the present invention; and

FIGS. 6 and 7 schematically illustrate network nodes according to the present invention.

### ABBREVIATIONS

ICID IMS Charging ID

IMS Internet Multimedia Subsystems

OSS Operation Support System

SIP Session Initiation Protocol

TSR Trace Session Reference

TRSR Trace Recording Session Reference

XML EXtensible Markup Language

### DETAILED DESCRIPTION

It is herein proposed to use the currently existing subscriber tracing framework defined in 3GPP, for the novel application of tracing based on the error code within the protocol messages for all the users. This proposition thus proposes to trace based on error codes instead of tracing on the activity of specific users.

Tracing on the error codes for all users may be applied to Session Initiation Protocol, SIP and the Diameter protocol.

These traces will be written by each NE and then fetched by the OSS for further analysis. When the end user calls the operator could filter by user identifier and find the errors associated to that specific user.

It is thus proposed to extend the subscriber tracing framework to allow tracing of error codes, so called “error tracing” for all subscribers.

For this purpose of error tracing, the same mechanisms as those used for activating and deactivating of subscriber tracing apply, with the exception that instead of providing user identifiers to trace on, the operator provides one or more error codes to trace on. Example of such an error response code is SIP 503. Wildcards representing codes can also be applied. Examples of wildcards of error codes in the SIP protocol are:
4xx Client Error; the request contains bad syntax or cannot be fulfilled at this server;
5xx Server Error; the server failed to fulfill an apparently valid request; and
6xx Global Failure; the request cannot be fulfilled at any server.

Examples of wildcards of error response codes in the Diameter protocol are:
3xxx, representing protocol errors;
4xxx, representing transient failures; and
5xxx, representing permanent failure.

Each network node will be configured with trace configuration parameters which can include one or several error codes, comprising error response wildcards and the following protocols. For instance:
Diameter: 4xxx, 5xxx; and
SIP: 503, 4xx.

A trace session can be activated by receipt of trace configuration information, in the form, of protocol and list of error response codes with or without wildcards. Thus the trace session is activated based on an error code instead of being based on a user identifier.

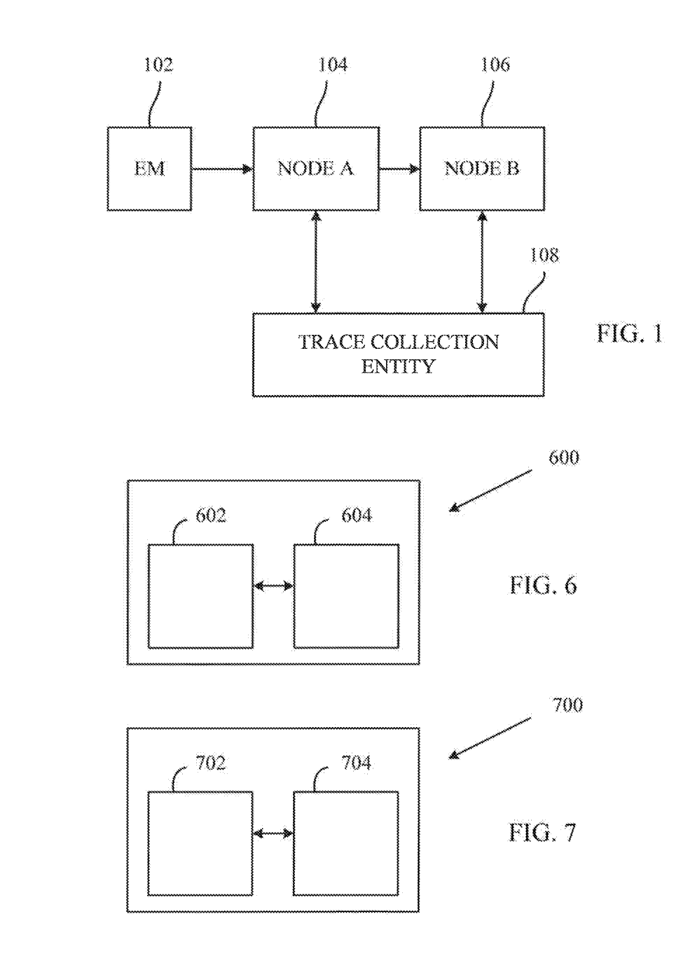

The present invention will now be described in some more detail. FIG. 1 presents a tracing enabled communication network related to the present invention. A network with an implemented tracing functionality typically comprises an Element Manager 102 that is configured to provide trace parameter configuration information to each network node. The network may further comprise a first network node, Node A 104, which can obtain an error message by either detecting an error or by receiving an error message from another network node. The network can further comprise one or more second network nodes, Node B 106, connected to the first network node. Both first and second network nodes, i.e. nodes A and B are can be connected to a trace collection entity 108, which is configured to collect trace records written as a result of a match between a trace configuration parameter and an error response code.

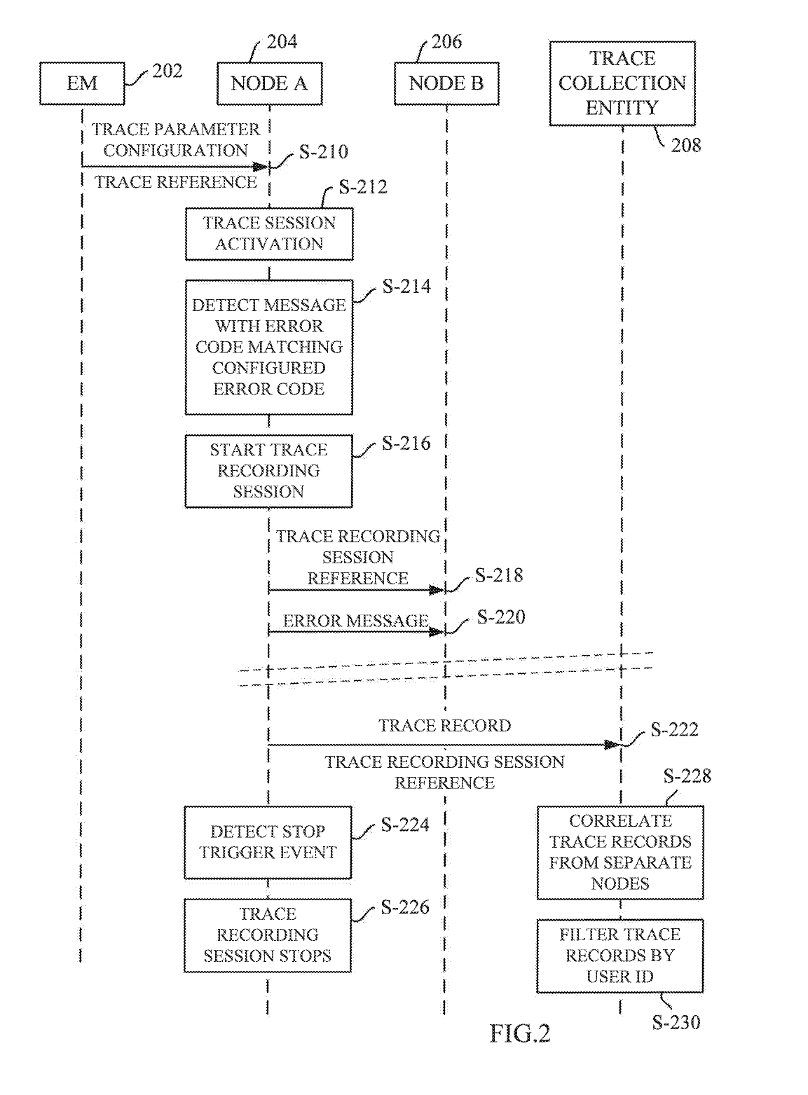

FIG. 2 illustrates a signal flow diagram related to embodiments of the present invention. An Element Manager 202 can provide trace parameter configuration information, and a globally unique Trace Session Reference, TSR number to a first network node, Node A 204, in step S-210. The trace parameter configuration information, typically comprises a list of error codes comprising start and stop criteria for trace recording sessions.

It can be mentioned that Node A 204 represents a network node which can obtain an error message by either detecting an internal error or by receiving an error message from another network node.

Upon receipt of trace parameter configuration information from the Element Manager 202, the first network node, Node A 204 activates a trace session, step S-212. The first network node may receive several error codes. After receipt of each error code, the first network node typically attempts to match the received error code with the error response codes from a list of error codes as received with the trace parameter configuration information.

The first network node 204 detects matching between the received error code and a configured error code, if the error message as received is comprised in the list of the configured error codes, step S-214.

Having detected a match, a criterion is fulfilled to start a trace recording session in step S-216. The first network node can then send a Trace Recording Session Reference, TRSR to a second network node, Node B 206 in step S-218. Also, the first network node 204 also sends an error message to the second network node 206, step S-220.

At the second network node 206 the error message sent from the first network node may then again match a configured error code at the second network node and so on.

Starting of a trace recording session initiates recording of a trace record, which can be provided to a trace collection entity 208, together with the TRSR, step S-222. This trace record can be provided in the form of a XML file. This trace record may also comprise the error message with error codes which matched the trace parameter configuration information.

According to an alternative embodiment the trace collection entity correlates trace records from network nodes according to TRSR numbers. It can further be added that the collection entity may fetch trace records according to a variety of different criteria.

Subsequently, the first network node 204 can detect a stop trigger event, step S-224, which initiates stopping of the trace recording session in step S-226.

Having received one or more trace records, the trace collection entity 208 can correlate the trace records that can be received from separate network nodes, step S-228. Filtering or sorting of the correlated trace records can then be performed in step S-230 by the trace collection entity, for troubleshooting the network and locating a network error.

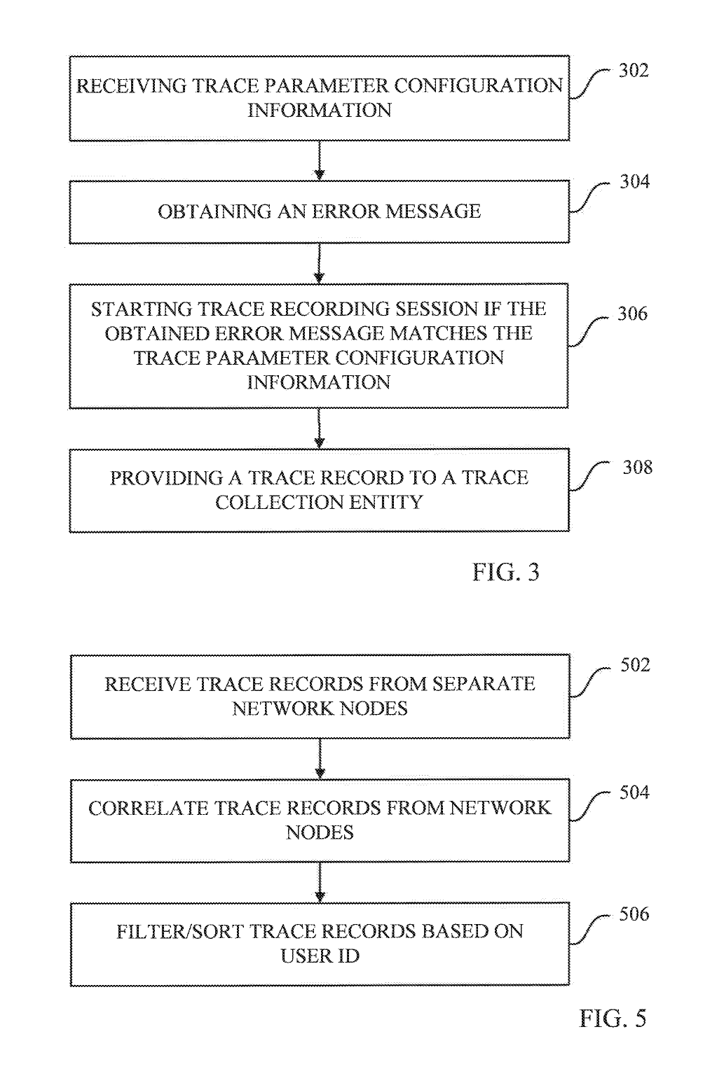

In the following flowcharts of method steps of methods according to embodiments of the present invention will be presented. FIG. 3 illustrates a flowchart of method steps of a method for providing trace records having error history information, with a network node, according to an embodiment of the present invention.

This method starts with step 302 of receiving trace parameter configuration information from n Element Manager, EM. The receipt of trace parameter configuration information activates a trace session. Then network node then obtains an error message in step 304. The network node starts a trace recording session if the obtained error message matches the trace parameter configuration information in step 306. In step 308, a trace record is then provided to a trace collection entity for troubleshooting of the network.

FIG. 4 illustrates a flowchart of method steps in a network node according to an alternative embodiment of the present invention. In step 402 a network node receives a trace session activation by receiving a lost of error codes comprising start and stop criteria for a trace recording session. The list of error codes is typically comprised in trace parameter configuration information as received from the Element Manager, EM. Thus, having received trace session activation, a trace session is started by the network node in step 404.

Among the messages sent via the network node, the network node can receive error messages from another network node, in step 406. This error message is now compared to the configured error codes in step 408. Also, in the case the error message matches the configured error code in step 410, the network node will start a trace recording session and obtain a Trace Recording Session Reference, TRSR for said session, in step 412

Upon starting trace recording session a file a trace record is recorded, typically in an XML format file. This file will later be provided to a trace collection entity, as will be discussed below.

It can be mentioned that the network node can receive the TRSR from the Operation Support System, OSS comprising the Element Manager, EM.

In the case there is no match between the error message and the configured error codes, the network node awaits an error message from a network node in step 406. If there is no reason to start a trace recording session, new error messages are thus awaited.

If a match was detected and a trace recording session started in step 412, the error message will be send further to another network nodes connected with the network nodes in which the method is performed, step 414.

Upon receipt of such an error message by said another network node, a novel matching attempt is performed, similar to the one executed in step 408. The error message that triggers trace recording session to start by fulfilling a start criterion will thus be forwarded to subsequent network nodes.

It can be mentioned that the error code is usually associated with the protocol to which it belongs, so that an error code may be Session Initiation protocol, SIP 503, which is the error code within SIP for an unavailable service. These aspects of error codes are discussed above.

Having sent the error message in step 414, the network node sends the TRSR to a trace collection entity 208 in step 416 together with the trace record in step 418. Here the XML file may be provided to the trace collection entity. Alternatively, the trace collection entity fetches the trace records from the network nodes that have collected said trace records.

Subsequently, a stop criterion can be detected in step 420, which triggers the trace recording session to stop in step 422. Moreover, the network node may receive a trace session deactivation message in step 424, which causes the trace session of the network node to stop in step 426.

The trace collection entity 108, 208 will now be discussed. FIG. 5 illustrates a flowchart of method steps of a method in a network node for processing of one or more trace records with error history information, potentially related to a number of users, from network nodes for network troubleshooting. The first method step is obtaining trace records from separate nodes in step 502. The trace collection entity may then correlate the received trace records, step 504. Subsequently, filtering or sorting of trace records based on user identity can then be performed, step 506.

As discussed above, when a user A attempting to call a user B and problems occur, network troubleshooting can now be performed based or error messages. Filtering or sorting can thus be done based on either user A, user B or both.

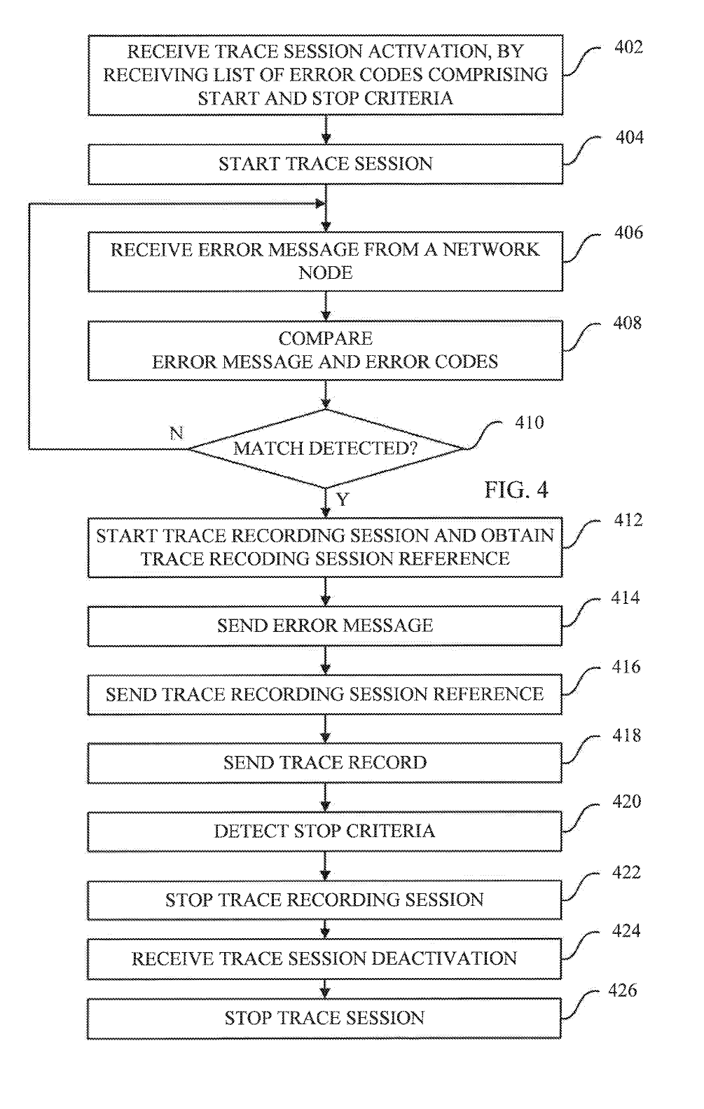

In the following the network nodes will be briefly described. With reference to FIG. 6 a network node 600 for providing trace records having error history information, is discussed. The network node 600 comprises a transceiving unit 602 that is configured to receive trace parameter configuration information. The transceiving unit is further configured to obtain an error message step S-210, 302, 402. The network node 600 also comprises a control unit 604 that is operatively connected to the receiving unit 602. The control unit is further configured to start trace recording session step S-216, 306, 412 if the obtained error message matches the trace parameter configuration information. In addition, the transceiving unit 602 is also configured to provide a trace record to the trace collection entity 108, 208.

With reference to FIG. 7 a network node or a trace collection entity 700 for processing of trace records with error history information, related to a number of users, from network nodes 600 for network troubleshooting, is briefly discussed. The trace collection entity 700 comprises a receiving unit 702 that is configured to receive trace records step S-222 having error history information from at least a first network node 600. The trace collection entity also comprises a control unit 704 that is operatively connected to the receiving unit 702, and configured to correlate trace records steps S-228, 504 having error history information from at least a first network node 600. Also, the control unit 704 is further configured to filter the correlated trace records based on user identities step S-230, 506.

It can be clarified that if trace parameter configuration information comprises, fro example, SIP 4xx and 5xx and Diameter 5xxx and 4xxx, tracing will then be performed on these error codes since trace recording sessions will be initiated and trace records recorded initiated by detected matching of error messages and error codes.

It must be emphasized that the present invention can be varied in many ways.

The presented embodiments of the present invention are only a few examples of the variety of embodiments that are comprised within the present invention.

The embodiments of the present invention provide at least the following advantages:

Traces containing the error will be available before the user calls with his complaint, since tracing based on errors can be activated in beforehand. This allows the operator to react better and faster when the user calls or even before the user calls, performing some preventive actions.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

It is made clear that presented embodiments may well be combined forming new embodiments not explicitly described herein.

In the claims, the term “comprises/comprising” does not exclude the presence of other elements or steps. Furthermore, although individually listed, a plurality of means, or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1-10. (canceled)

11. A method in a network node for providing trace records having error history information, said method comprising:
receiving trace parameter configuration information from an Element Manager (EM) activating a trace session;
obtaining an error message;
starting a trace recording session if the obtained error message matches the trace parameter configuration information; and
providing a trace record to a trace collection entity, for troubleshooting of the network.

12. The method of claim 11, wherein obtaining an error message comprises detecting an error message within the network node.

13. The method of claim 11, wherein obtaining an error message comprises receiving an error message from another network node.

14. The method of claim 11, further comprising comparing the obtained error message and the trace parameter configuration information to determine whether the obtained error message matches the trace parameter configuration information.

15. The method of claim 11, further comprising waiting for an obtaining of another error message, in absence of a match between the obtained error message and the trace parameter configuration information.

16. The method of claim 11, further comprising detecting an event triggering stopping of the trace recording session.

17. A method in a network node for processing of trace records with error history information, related to a number of users, from network nodes for network troubleshooting, said method comprising:
receiving at least one trace record having error history information from at least a first network node;
correlating said trace records with one another; and
filtering the correlated trace records based on user identities.

18. The method of claim 17, further comprising receiving a trace recording session reference for each trace record, and wherein correlating said trace records is based on one or more received trace recording session references.

19. A network node for providing trace records having error history information, said network node comprising:
a transceiving unit configured to receive trace parameter configuration information, obtain an error message, and provide a trace record to a trace collection entity, for troubleshooting of the network; and
a control unit operatively connected to the receiving unit and configured to start a trace recording session if the obtained error message matches the trace parameter configuration information.

20. A network node for processing of trace records with error history information, related to a number of users, from network nodes for network troubleshooting, said network node comprising:
a receiving unit configured to receive trace records having error history information from at least a first network node; and
a control unit operatively connected to the receiving unit and configured to correlate trace records having error history information from at least a first network node and to filter the correlated trace records based on user identities.
